(19) United States
(12) Patent Application Publication
(10) Pub. No.: US 2018/0134938 A1
(43) Pub. Date: May 17, 2018

(54) THERMALLY CONDUCTIVE COMPOSITION

(71) Applicant: Momentive Performance Materials Japan LLC, Minato-ku, Tokyo (JP)

(72) Inventors: Daigo HIRAKAWA, Minato-ku, Tokyo (JP); Masanori TAKANASHI, Minato-ku, Tokyo (JP)

(21) Appl. No.: 15/574,642

(22) PCT Filed: May 18, 2016
(86) PCT No.: PCT/JP2016/064725

§ 371 Date: Nov. 16, 2017

(30) Foreign Application Priority Data
May 22, 2015 (JP) 2015-104113

(51) Int. Cl. C09K 5/14; C08K 3/38; C08K 3/28; C08K 7/18

(52) U.S. Cl. CPC C09K 5/14; C08K 3/38; C08K 3/28; C08K 7/18; C08K 2201/003; C08K 2003/385; C08K 2003/282; C08K 2201/001; C08K 2201/005

(57) ABSTRACT

The present invention provides a thermally conductive composition good in thermal conductivity, low in viscosity and easy in application. The thermally conductive composition is a thermally conductive composition including (A) a spherical thermally conductive filler and (B) an alkoxysilane compound or dimethylpolysiloxane, wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more.

### FIELD OF THE INVENTION

The present invention relates to a thermally conductive composition capable of being used as a heat dissipating material, and a heat dissipating material using the thermally conductive composition.

### BACKGROUND OF THE INVENTION

Electronic devices are undergoing increasingly higher integration and higher speed-up year by year, and accordingly the demand for heat dissipating materials as the countermeasures coping with the generated heat has been enhanced.

JP-A 62-43493 describes an invention of a thermally conductive silicone grease having a good thermal conductivity and a good electrical insulation. The document describes use of a boron nitride having a particle size of 0.01 to 100 μm as a component imparting the thermal conductivity (p.2, in the lower section of the right column), and a boron nitride having a particle size of 1 to 5 μm is used in the Example.

JP-A 2003-176414 describes an invention of a thermally conductive silicone composition, and describes as a component imparting the thermal conductivity, (B) a low-melting-point metal powder having an average particle size of 0.1 to 100 μm, and preferably 20 to 50 μm (paragraph 0011), and (D) a filler (paragraph 0014).

JP-A 2003-218296 describes an invention of a silicone resin composition including a silicone resin and a thermally conductive filler, and describes as the thermally conductive filler, for example, a low-melting-point metal powder, and an aluminum powder, a zinc oxide powder, and an alumina powder each having an average particle size of 0.1 to 100 μm, and preferably 20 to 50 μm (paragraphs 0017 to 0021).

JP-A 2003-301189 describes an invention of a heat dissipating silicone grease composition, and describes the use of a thermally conductive filler having an average particle size falling within a range of 0.1 to 100 μm, and preferably 1 to 20 μm (paragraphs 0012 and 0013).

JP-A 2005-112961 describes an invention of a curable organopolysiloxane composition, and describes the use of a thermally conductive filler having an average particle size of 0.1 to 100 μm, and preferably 1 to 20 μm (paragraphs 0030 to 0032)

JP-A 2007-99821 describes an invention of a thermally conductive silicone grease composition, and describes the use of powders having an average particle size of 0.1 to 10 μm, and preferably 0.2 to 8 μm, as a metal oxide powder or a metal nitride powder of component (B) in order to obtain a desired thermal conductivity (paragraphs 0016 and 0017).

JP-A 2008-184549 describes an invention of a method for producing a heat dissipating material. The invention uses as (D) a thermally conductive filler, a thermally conductive filler having an average particle size of 100 μm or less, and preferably 0.1 to 80 μm (paragraphs 0027 and 0028). In Example 1, an aluminum oxide (D-1) having an average particle size of 14 μm, an aluminum oxide (D-2) having an average particle size of 2 μm, and a zinc oxide (D-3) having an average particle size of 0.5 μm are used in combination.

JP-A 2009-96961 describes an invention of a thermally conductive silicone grease composition, and describes the use of (B-1) a thermally conductive filler having an average particle size of 12 to 100 μm (preferably 15 to 30 μm), and (B-2) a thermally conductive filler having an average particle size of 0.1 to 10 μm (preferably 0.3 to 5 μm) (claims, and paragraphs 0028 to 0030).

JP-A 2010-13563 describes an invention of a thermally conductive silicone grease, and states that (A) a thermally conductive inorganic filler preferably has an average particle size falling within a range of 0.1 to 100 μm, in particular, 1 to 70 μm (paragraph 0025). In Examples, there are used B-1: a zinc oxide powder (amorphous, average particle size: 1.0 μm), B-2: an alumina powder (spherical, average particle size: 2.0 μm), and B-3: an aluminum powder (amorphous, average particle size: 7.0 μm).

JP-A 2010-126568 describes an invention of a silicone grease composition for heat dissipation, and states that (B) a thermally conductive inorganic filler is required to have an average particle size falling within a range of 0.1 to 100 μm, and preferably has an average particle size falling within a range of 0.5 to 50 μm.

In Examples, there are used an alumina powder C-1: (average particle size: 10 μm, specific surface area: 1.5 m²/g), an alumina powder C-2: (average particle size: 1 μm, specific surface area: 8 m²/g), a zinc oxide powder C-3: (average particle size: 0.3 μm, specific surface area: 4 m²/g), an aluminum powder C-4: (average particle size: 10 μm, specific surface area: 3 m²/g), and an alumina powder C-5: (average particle size: 0.01 μm, specific surface area: 160 m²/g).

JP-A 2011-122000 describes an invention of a silicone composition for a highly thermally conductive potting material, and describes the use of a thermally conductive filler having an average particle size of 1 to 100 μm, preferably 5 to 50 μm as (A) a thermally conductive filler (paragraph 0018). It is stated that when an alumina powder is used as (A) the thermally conductive filler, (B1) a spherical alumina having an average particle size of more than 5 μm to 50 μm or less, and (B2) a spherical or amorphous alumina having an average particle size of 0.1 μm to 5 μm are preferably used in combination (paragraph 0018).

JP-A 2013-147600 describes an invention of a thermally conductive silicone composition. It is stated that a thermally conductive filler being component (B) mainly includes alumina, and is composed of (C-i) an amorphous alumina having an average particle size of 10 to 30 μm, (C-ii) a spherical alumina having an average particle size of 30 to 85 μm, and (C-iii) an insulating inorganic filler having an average particle size of 0.1 to 6 μm (paragraph 0032). A combination of an amorphous alumina and a spherical alumina allows a specific effect to be obtained.

### SUMMARY OF THE INVENTION

An object of the present invention is to provide a thermally conductive composition having a good thermal conductivity and being capable of being made to have a low viscosity, and a heat dissipating material using the thermally conductive composition.

A first embodiment of the present invention provides a thermally conductive composition including (A) a spherical thermally conductive filler and (B) an alkoxysilane compound or dimethylpolysiloxane, wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more.

A second embodiment of the present invention provides a thermally conductive composition including (A) a spherical thermally conductive filler and (B) an alkoxysilane compound or dimethylpolysiloxane, wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more; and being formulated with a spherical thermally conductive filler having an average particle size of less than 1 μm in an amount of 10% by mass or more.

The present invention further provides a heat dissipating material using the composition according to the first or second embodiment.

The composition of the present invention has a high thermal conductivity, but is capable of being made to have a low viscosity, and accordingly is easy to apply to an application object when the composition is used as a heat dissipating material.

### DESCRIPTION OF EMBODIMENTS

<Thermally Conductive Composition of First Embodiment>

The thermally conductive composition of the first embodiment of the present invention includes (A) a spherical thermally conductive filler and (B) an alkoxysilane compound or dimethylpolysiloxane.

[Component (A)]

Component (A) is a spherical thermally conductive filler, and does not include any amorphous thermally conductive filler. The spherical shape is not required to be a perfect sphere, but when a major axis and a minor axis are involved, the spherical shape means a shape approximately satisfying the ratio of major axis/minor axis=1.0±0.2.

The spherical thermally conductive filler of component (A) is a mixture formulated with specific ratios of fillers having different average particle sizes, and from the viewpoint of being capable of enhancing the thermal conductivity, the mixture is formulated with a filler having an average particle size of 50 μm or more in an amount of 30% by mass or more, preferably 40% by mass or more and more preferably 50% by mass or more.

In one example, the mixture of component (A) is formulated with a spherical thermally conductive filler having an average particle size of 50 μm or more in an amount of 50% by mass or more, and is preferably formulated with a spherical thermally conductive filler having an average particle size of less than 50 μm in an amount of 50% by mass or less.

In another example, the mixture of component (A) is preferably formulated with a spherical thermally conductive filler having an average particle size of 50 μm or more, preferably an average particle size of 50 to 100 μm, and more preferably an average particle size of 50 to 80 μm, in an amount of 50 to 70% by mass, and preferably 50 to 60% by mass, and more preferably includes a spherical thermally conductive filler having an average particle size of less than 50 μm, preferably an average particle size of 1 to 10 μm, and more preferably an average particle size of 1 to 5 μm, in an amount of 30 to 50% by mass, and preferably 40 to 50% by mass.

The spherical thermally conductive filler having an average particle size of 50 μm or more is made of a nitride, and the nitride is preferably aluminum nitride or boron nitride from the viewpoint of thermal conductivity. The spherical thermally conductive filler having an average particle size of 50 μm or more uses neither a metal oxide such as aluminum oxide or zinc oxide nor a metal such as aluminum. As the spherical thermally conductive filler made of a nitride and having an average particle size of 50 μm or more, for example, a roundish aluminum nitride “FAN-f50-J (average particle size: 50 μm)” and ditto “FAN-f80 (average particle size: 80 μm)” sold by Tokuyama Corporation can be used.

The spherical thermally conductive filler having an average particle size of less than 50 μm is also preferably made of a nitride, and as such a spherical thermally conductive filler, for example, a roundish aluminum nitride “HF-01 (average particle size: 1 μm)” and ditto “HF-05 (average particle size: 5 μm)” sold by Tokuyama Corporation can be used. However, other spherical metal oxide powders and metal powders can also be used such as those selected from aluminum oxide, zinc oxide and aluminum. The spherical thermally conductive filler having an average particle size of less than 50 μm can be used by formulating two or more kinds that are different in average particle size.

[Component (B)]

The alkoxysilane compound of component (B) is preferably a compound having at least an alkoxysilyl group represented by the following general formula in one molecule:

—SiR¹¹₃-a(OR¹²)ₐ (II),

wherein R¹¹ is an alkyl group having 1 to 6 carbon atoms, and preferably a methyl group; R¹² is an alkyl group having 1 to 6 carbon atoms, and preferably a methyl group; and a is 1, 2 or 3.

Examples of the alkoxysilane compound having the alkoxysilyl group represented by the general formula (II) may include the compound represented by the following general formula (II-1) and the compound represented by the following general formula (II-2):

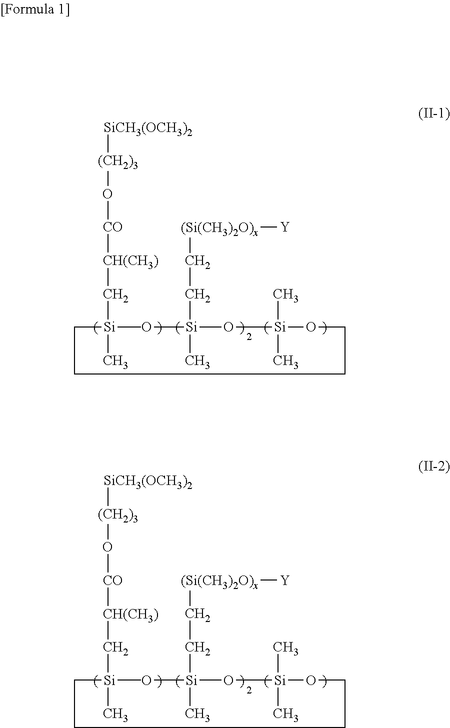

wherein

x=10 to 500, and

Y=Si(CH₃)₂CH═CH₂ or Si(CH₃)₃.

As the alkoxysilane compound of component (B), the compound represented by the following general formula (III) can also be used:

R²¹ₐR²²_{b}Si(OR²³)_{4-a-b} (III)

wherein R²¹ is independently an alkyl group having 6 to 15 carbon atoms; R²² is independently an unsubstituted or substituted monovalent hydrocarbon group having 1 to 12 carbon atoms; R²³ is independently an alkyl group having 1 to 6 carbon atoms; a is an integer of 1 to 3; and b is an integer of 0 to 2, with the proviso that a+b is an integer of 1 to 3.

In the general formula (III), examples of the alkyl group represented by R²¹ may include a hexyl group, an octyl group, a nonyl group, a decyl group, a dodecyl group, and a tetradecyl group. As the unsubstituted or substituted monovalent hydrocarbon group represented by R²², preferable are unsubstituted or substituted alkyl groups having 1 to 3 carbon atoms such as a methyl group, an ethyl group, a propyl group, a chloromethyl group, a bromoethyl group, a 3,3,3-trifluoropropyl group, and a cyanoethyl group; and unsubstituted or substituted phenyl groups such as a phenyl group, a chlorophenyl group, and a fluorophenyl group. As the R²³, for example, preferable are, a methyl group, an ethyl group, a propyl group, a butyl group, and a hexyl group.

Examples of the dimethylpolysiloxane of component (B) may include a dimethyl polysiloxane in which one of the molecular chain terminals represented by the following general formula (IV) is blocked with a trialkoxysilyl group:

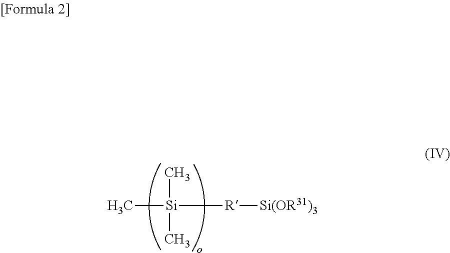

R′=—O— or —CH₂CH₂—

wherein R³¹ is independently an alkyl group having 1 to 6 carbon atoms; and c is an integer of 5 to 100, preferably 5 to 70, and particularly preferably 10 to 50.

As the alkyl group represented by R³¹, for example, preferable are a methyl group, an ethyl group, a propyl group, a butyl group, and a hexyl group.

Further, as component (B), for example, a surface treatment agent (wetter) (paragraphs 0041 to 0048) of component (D) described in JP-A 2009-221311 can also be used.

The content of component (B) in the composition of the first embodiment is 1 to 30 parts by mass, preferably 1 to 25 parts by mass, and more preferably 5 to 20 parts by mass, relative to 100 parts by mass of component (A).

<Thermally Conductive Composition of Second Embodiment>

The thermally conductive composition of the second embodiment of the present invention also includes (A) a spherical thermally conductive filler and (B) an alkoxysilane compound or dimethylpolysiloxane.

[Component (A)]

Component (A) is a spherical thermally conductive filler, and does not include any amorphous thermally conductive filler. The spherical shape is not required to be a perfect sphere, but when a major axis and a minor axis are involved, the spherical shape means a shape approximately satisfying the ratio of major axis/minor axis=1.0±0.2.

The spherical thermally conductive filler of component (A) is a mixture formulated with specific ratios of fillers having different average particle sizes, and from the viewpoint of being capable of enhancing the thermal conductivity, the mixture is formulated with a filler having an average particle size of 50 μm or more in an amount of 30% by mass or more, preferably 40% by mass or more and more preferably 50%& by mass or more.

The spherical thermally conductive filler of component (A) is a mixture formulated with specific ratios of fillers having different average particle sizes, namely, a spherical thermally conductive filler having an average particle size of 50 μm or more and a spherical thermally conductive filler having an average particle size of less than 1 μm.

In the mixture of component (A), the spherical thermally conductive filler having an average particle size of 50 μm or more is formulated in an amount of 30% by mass or more, preferably 40% by mass or more, and more preferably 50% by mass or more, from the viewpoint of being capable of enhancing the thermal conductivity. In one example, the mixture of component (A) is formulated with a spherical thermally conductive filler having an average particle size of 50 μm or more, preferably an average particle size of 50 to 100 μm, and more preferably an average particle size of 50 to 80 μm in an amount of 50 to 70% by mass, and preferably 50 to 60% by mass.

From the viewpoint of suppressing the increase of the viscosity and enhancing the thermal conductivity, in the mixture of component (A), the spherical thermally conductive filler having an average particle size of less than 1 μm is formulated in an amount of 10% by mass or more, and preferably 15% by mass or more. In one example, in the mixture of component (A), the spherical thermally conductive filler having an average particle size of less than 1 μm is preferably formulated in an amount of 10 to 30% by mass, and more preferably 15 to 25% by mass.

The mixture of component (A) is preferably formulated with, as a balance excluding the spherical thermally conductive filler having an average particle size of 50 μm or more and the spherical thermally conductive filler having an average particle size of less than 1 μm, a spherical thermally conductive filler having an average particle size of 1 μm or more and less than 50 μm, preferably an average particle size of 1 to 10 μm, and more preferably an average particle size of 1 to 5 μm.

In the mixture of component (A), the spherical thermally conductive filler having an average particle size of 50 μm or more is made of a nitride, and the nitride is preferably aluminum nitride or boron nitride, from the viewpoint of thermal conductivity. As the spherical thermally conductive filler made of a nitride and having an average particle size of 50 μm or more, a roundish aluminum nitride “FAN-f50-J (average particle size: 50 μm)” and a ditto “FAN-f80 (average particle size: 80 μm)” sold by Tokuyama Corporation can be used.

The spherical thermally conductive filler having an average particle size of 1 μm or more and less than 50 μm, preferably an average particle size of 1 to 10 μm, and more preferably an average particle size of 1 to 5 μm is preferably a spherical thermally conductive filler made of a nitride, and as such a spherical thermally conductive filler, for example, a roundish aluminum nitride “HF-01 (average particle size: 1 μm)” and a ditto “HF-05 (average particle size: 5 μm)” sold by Tokuyama Corporation can be used. However, other spherical metal oxide powders and metal powders can also be used such as those selected from aluminum oxide, zinc oxide, and aluminum.

As the spherical thermally conductive filler having an average particle size of less than 1 μm, there can be used a filler selected from metal oxides such as aluminum oxide (Al₂O₃) and zinc oxide (ZnO), nitrides such as aluminum nitride and boron nitride, metals such as aluminum, copper, silver, and gold, and metal/metal oxide core-shell-type particles.

[Component (B)]

The same alkoxysilane compound or the dimethylpolysiloxane as used in the thermally conductive composition of the first embodiment can be used.

The content of component (B) in the composition of the second embodiment is 1 to 20 parts by mass, preferably 1 to 15 parts by mass, and more preferably 3 to 15 parts by mass, relative to 100 parts by mass of component (A).

[Other Components]

The composition of the first embodiment and the composition of the second embodiment can each further include polyorganosiloxane as component (C), in addition to component (A) and component (B). In the polyorganosiloxane of component (C), the dimethylpolysiloxane of component (B) is not included.

[Component (C)]

As the polyorganosiloxane of component (C), a polyorganosiloxane represented by the following average compositional formula (I) can be used:

R¹ₐR²_{b}SiO_{[4-(a+b)]/2} (I)

In the formula, R¹ is an alkenyl group. The alkenyl group is preferably an alkenyl group having carbon atoms within a range of 2 to 8; examples of such an alkenyl group may include a vinyl group, an allyl group, a propenyl group, a 1-butenyl group, and a 1-hexenyl group; the alkenyl group is preferably a vinyl group. When the alkenyl group is included, preferably one or more alkenyl groups are included in one molecule, and preferably two or more alkenyl groups are included in one molecule. When one or more alkenyl groups are included in one molecule, component (C) can be regulated between a gel state and a rubber state. The alkenyl groups may be bonded either to silicon atoms at molecular chain terminals or to silicon atoms midway the molecular chain, or alternatively may be bonded to both of the above.

R² is a substituted or unsubstituted monovalent hydrocarbon group free from any aliphatic unsaturated bond. The substituted or unsubstituted monovalent hydrocarbon group free from aliphatic unsaturated bond is a group having 1 to 12 carbon atoms, and preferably 1 to 10 carbon atoms; examples of such a substituted or unsubstituted monovalent hydrocarbon group include: alkyl groups such as a methyl group, an ethyl group, a propyl group, an isopropyl group, a butyl group, a hexyl group, an octyl group, a decyl group, and a dodecyl group; cycloalkyl groups such as a cyclopentyl group, a cyclohexyl group, and a cyclobutyl group; aryl groups such as a phenyl group, a tolyl group, a xylyl group, and a naphthyl group; aralkyl groups such as a benzyl group, a phenylethyl group, and a phenylpropyl group; groups obtained by substituting part or the whole of the hydrogen atoms of these hydrocarbon groups with halogen atoms such as chlorine, fluorine and bromine atoms, or cyan groups, such as halogenated hydrocarbon groups such as a chloromethyl group, a trifluoropropyl group, a chlorophenyl group, a bromophenyl group, a dibromophenyl group, a tetrachlorophenyl group, a fluorophenyl group, and a difluorophenyl group, and such as cyanoalkyl groups such as an α-cyanoethyl group, a β-cyanopropyl group, and a γ-cyanopropyl groups. Among these, alkyl groups and aryl groups are preferable, and a methyl group and a phenyl group are more preferable.

a and b are positive numbers satisfying 0a≤3, 0<b<3, and 1<a+b<3, preferably numbers satisfying 0.0005≤a≤1, 1.5≤b<2.4, 1.5<a+b<2.5, and more preferably numbers satisfying 0.001≤a≤0.5, 1.8≤b≤2.1, 1.8<a+b≤2.2.

The molecular structure of component (C) is preferably a linear structure or a branched structure.

The viscosity of component (C) at 23° C. is preferably 0.01 to 10 Pa·s, and more preferably 0.02 to 1.0 Pa·s.

When component (C) is included, the total amount of component (B) and component (C) is 1.5 to 35 parts by mass, preferably 1.5 to 30 parts by mass, and more preferably 1.5 to 28 parts by mass relative to 100 parts by mass of component (A). Component (B) and component (C) are formulated in such a way that the content ratio of component (C) in the total amount of component (B) and component (C) is 15 to 98% by mass, preferably 18 to 98% by mass, and more preferably 20 to 98% by mass.

The composition of the present invention can include, if necessary, a reaction inhibitor, a reinforcing silica, a flame retardancy-imparting agent, a heat resistance improver, a plasticizer, a colorant, an adhesion imparting agent, and a diluent, within the ranges not impairing the object of the present invention.

The compositions of the first and second embodiments of the present invention are grease-like (paste-like) compositions. When as component (B), the alkoxysilane compounds (II-1, 2) with Y═Si(CH₃)₂CH₂═CH₂ are used, by selecting the substituent of component (C) so as to include an unsaturated group, and by using the following component (D) and the following component (E) in combination, the hardness of the composition can be regulated between the gel-like composition and the rubber-like composition. Herein, when a rubber-like composition is prepared, the rubber-like composition involves compositions ranging from an elastic composition to a composition hard like a stone.

[Component (D)]

Component (D) is a polyorganohydrogensiloxane, and is a component to be a cross-linking agent for component (C). The polyorganohydrogensiloxane of component (D) has, in a molecule thereof, two or more, and preferably three or more hydrogen atoms bonded to silicon atoms. Such hydrogen atoms may be bonded either to silicon atoms at molecular chain terminals or to silicon atoms midway the molecular chain, or alternatively may be bonded to both of the above. Moreover, a polyorganohydrogensiloxane having hydrogen atoms bonded only to the silicon atoms at both terminals can be used in combination. The molecular structure of component (D) may be any of a linear, branched, cyclic or three-dimensional network structure, and these structures may be used each alone or in combinations of two or more thereof. The polyorganohydrogensiloxane of component (D) is a heretofore known product, and for example, component (B) described in JP-A 2008-184549 can be used.

[Component (E)]

Component (E) is a platinum-based catalyst, and a component to promote the curing after the kneading of component (C) and component (D). As component (E), heretofore known catalysts used for hydrosilylation reaction can be used. Examples of such catalysts include: platinum black, platinic chloride, chloroplatinic acid, a reaction product between chloroplatinic acid and a monohydric alcohol, complexes of chloroplatinic acid, olefins and vinylsiloxane, and platinum bisacetoacetate. The content of component (E) can be appropriately regulated according to the desired curing rate or the like, and is preferably 0.1 to 1000 ppm, in terms of the platinum element, relative to the total amount of component (C) and component (D).

The composition of the present invention can be obtained by mixing component (A) and component (B), and further, if necessary, other optional components by using a mixer such as a planetary mixer. During the mixing, the mixing may be performed while heating in a range from 50 to 150° C., if necessary. Moreover, for uniform finish, a kneading operation is preferably performed under high shear force. As a kneading apparatus, for example, a triple roll mill, a colloid mill, and a sand grinder are available, and among these, the triple roll mill offers a preferable method.

When the composition of the present invention is a gel-like composition including component (D) and component (E), the composition can be obtained in the same manner as in the method for producing a heat dissipating material described in JP-A 2008-184549.

The heat dissipating material made of the composition of the present invention is a heat dissipating material made of an above-described thermally conductive composition. When the heat dissipating material made of the composition of the present invention is a grease-like material not including component (D) and component (E), the viscosity (the viscosity obtained by the measurement method described in Examples) preferably falls within a range from 10 to 1000 Pa·s, from the viewpoint of easiness in application to a heat-generating portion.

When a heat dissipating material made of a composition in which, as described above, component (B) is the alkoxysilane compounds (II-1, 2) including Y═Si(CH₃)₂CH₂═CH₂, is a rubber-like material including component (C), component (D) and component (E), the heat dissipating material preferably has a hardness of, for example, 5 or more as measured with a type E durometer (in accordance with JIS K6249).

The heat dissipating material made of the composition of the present invention has a thermal conductivity at 23° C., measured with a hot wire method, of 2.0 W/(m·K) or more, preferably 2.5 W/(m·K) or more, and more preferably 3.0 W/(m·K) or more. In order to enhance the heat dissipation effect by regulating the thermal conductivity, the proportion of component (A) in the composition is preferably 80% by mass or more; according to the required thermal conductivity, the proportion of component (A) can be increased.

The heat dissipating material of the present invention can be used as the heat dissipating material for PCs/servers mounting CPUs being large in heat generation amount, and additionally, as the heat dissipating materials for power modules, VLSIs, various electronic devices mounting optical components (optical pickups and LEDs), household appliances (DVD/HDD recorders (players), AV appliances such as FPDs), PC peripheral devices, home video game machines, automobiles, and industrial devices such as inverters and switched-mode power supplies. The heat dissipating material is allowed to have, for example, a grease-like form (paste-like form), a gel-like form and a rubber-like form.

Hereinafter, various embodiments of the present invention are described.

<1> A thermally conductive composition including (A) a spherical thermally conductive filler and (B) an alkoxysilane compound or a dimethylpolysiloxane,

wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more, preferably 40% by mass or more, and more preferably 50% by mass or more.

<2> The thermally conductive composition according to <1>, wherein the mixture of component (A) is formulated with a spherical thermally conductive filler made of a nitride and having an average particle size of 50 μm or more in an amount of 50% by mass or more; and is formulated with a spherical thermally conductive filler having an average particle size of less than 50 μm in an amount of 50% by mass or less.

<3> A thermally conductive composition including (A) a spherical thermally conductive filler and (B) an alkoxysilane compound or dimethylpolysiloxane,

wherein the spherical thermally conductive filler of component (A) is a mixture formulated with specific ratios of fillers having different average particle sizes, the mixture being formulated with a spherical thermally conductive filler made of a nitride and having an average particle size of 50 to 100 μm, and preferably an average particle size of 50 to 80 μm, in an amount of 50 to 70% by mass, and preferably 50 to 60% by mass.

<4> The thermally conductive composition according to <3>, wherein the mixture of component (A) is formulated with a spherical thermally conductive filler having an average particle size of 1 to 10 μm, and preferably an average particle size of 1 to 5 μm, in an amount of 30 to 50% by mass, and preferably 40 to 50% by mass.

<5> The thermally conductive composition according to any one of <1> to <4>, including component (B), the alkoxysilane compound or dimethylpolysiloxane, in an amount of 1 to 30 parts by mass, preferably 1 to 25 parts by mass, and more preferably 5 to 20 parts by mass, relative to 100 parts by mass of component (A).

<6> A thermally conductive composition including (A) a spherical thermally conductive filler and (B) an alkoxysilane compound or dimethylpolysiloxane,

wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more, preferably 40% by mass or more, and more preferably 50% by mass or more; and being formulated with a spherical thermally conductive filler having an average particle size of less than 1 μm in an amount of 10% by mass or more, and preferably 15% by mass or more.

<7> The thermally conductive composition according to <6>, wherein the mixture of component (A) is formulated with a spherical thermally conductive filler made of a nitride and having an average particle size of 50 μm or more in an amount of 30% by mass or more, preferably 40% by mass or more, and more preferably 50% by mass or more; is formulated with a spherical thermally conductive filler having an average particle size of less than 1 μm in an amount of 10% by mass or more, and preferably 15% by mass or more; and is formulated with a spherical thermally conductive filler having an average particle size of 1 μm or more and less than 50 μm as a balance.

<8> The thermally conductive composition according to <6> or <7>, wherein the mixture of component (A) is formulated with a spherical thermally conductive filler made of a nitride and having an average particle size of 50 to 100 μm, and preferably an average particle size of 50 to 80 μm, in an amount of 50 to 70% by mass, and preferably 50 to 60% by mass.

<9> The thermally conductive composition according to any one of <6> to <8>, wherein the mixture of component (A) is formulated with a spherical thermally conductive filler having an average particle size of less than 1 μm, in an amount of 10 to 30% by mass, and preferably 15 to 25% by mass.

<10> The thermally conductive composition according to any one of <6> to <9>, wherein the balance is formulated with a spherical thermally conductive filler having an average particle size of 1 to 10 μm, and preferably an average particle size of 1 to 5 μm.

<11> The thermally conductive composition according to any one of <6> to <10>, including component (B), the alkoxysilane compound or dimethylpolysiloxane, in an amount of 1 to 20 parts by mass, preferably 1 to 15 parts by mass, and more preferably 3 to 15 parts by mass, relative to 100 parts by mass of component (A).

<12> The thermally conductive composition according to any one of <6> to <11>, wherein the spherical thermally conductive filler having an average particle size of less than 1 μm is aluminum oxide or zinc oxide.

<13> The thermally conductive composition according to any one of <1> to <12>, wherein the nitride is aluminum nitride or boron nitride.

<14> A heat dissipating material made of the thermally conductive composition according to any one of <1> to <13>.

<15> A method for producing a thermally conductive composition, which includes mixing in 100 parts by mass of (A) a spherical thermally conductive filler, (B) an alkoxysilane compound or dimethylpolysiloxane in an amount of 1 to 30 parts by mass, preferably 1 to 25 parts by mass, and more preferably 5 to 20 parts by mass,

wherein component (A) is a mixture formulated with specific ratios of fillers having different average particle sizes, the mixture being formulated with a filler made of a nitride and having an average particle size of 50 μm or more, preferably an average particle size of 50 to 100 μm, and more preferably an average particle size of 50 to 80 μm, in an amount of 30% by mass or more, preferably 40% by mass or more, and more preferably 50% by mass or more.

<16> A method for producing a thermally conductive composition, which includes mixing in 100 parts by mass of (A) a spherical thermally conductive filler, (B) an alkoxysilane compound or dimethylpolysiloxane in an amount of 1 to 20 parts by mass, preferably 1 to 15 parts by mass, and more preferably 3 to 15 parts by mass,

wherein component (A) is a mixture formulated with specific ratios of fillers having different average particle sizes, the mixture being formulated with a filler made of a nitride and having an average particle size of 50 μm or more, preferably an average particle size of 50 to 100 μm, and more preferably an average particle size of 50 to 80 μm, in an amount of 30% by mass or more, preferably 40% by mass or more, and more preferably 50% by mass or more; and being also formulated with a spherical thermally conductive filler having an average particle size of less than 1 μm in an amount of 10% by mass or more, and preferably 15% by mass or more.

<17> The production method of <16> or <17>, wherein the nitride is aluminum nitride or boron nitride.

<18> The composition, the heat dissipating material or the production method of any one of <1> to <17>, wherein component (B) is an alkoxysilane compound having the alkoxysilyl group of the general formula (II).

<19> The composition, the heat dissipating material or the production method of <18>, wherein component (B) is the compound of the general formula (II-1) or the general formula (II-2).

<20> The composition, the heat dissipating material or the production method of any one of <1> to <17>, wherein component (B) is the compound represented by the general formula (III).

<21> The composition, the heat dissipating material or the production method of any one of <1> to <17>, wherein component (B) is the dimethylpolysiloxane represented by the general formula (IV).

<22> The composition, the heat dissipating material or the production method of any one of <1> to <17>, further including, as component (C), the polyorganosiloxane represented by the average compositional formula (I).

<23> The composition, the heat dissipating material or the production method of <22>, further including a polyorganohydrogensiloxane as component (D) and a platinum-based catalyst as component (E).

### EXAMPLES

<Components Used>

Component (A)

Roundish aluminum nitride “FAN-f80,” average particle size: 80 μm, Tokuyama Corporation

Roundish aluminum nitride “FAN-f50-J,” average particle size: 50 μm, Tokuyama Corporation

Roundish aluminum nitride “HF-05,” average particle size: 5 μm, Tokuyama Corporation

Roundish aluminum nitride “HF-01,” average particle size: 1 μm, Tokuyama Corporation

Roundish alumina “Sumicorandom,” average particle size: 0.4 μm, Sumitomo Chemical Co., Ltd.

Component (B)

The surface treatment agent (in the general formula (II-1), x:20, Y:Si(CH₃)₂CH═CH₂)

<Measurement Methods>

[Average Particle Size]

The average particle size (median diameter d₅₀) was measured by the Coulter counter method.

[Viscosity]

In accordance with JIS K6249. The viscosity with a rotary viscometer rotor No. 7, at a number of rotations of 20 rpm, and a measurement time of 1 minute is shown.

[Thermal Conductivity]

The thermal conductivity was measured at 23° C., according to a hot wire method, by using a thermal conductivity meter (QTM-500, manufactured by Kyoto Electronics Manufacturing Co., Ltd.).

### Examples 1 to 18

Components (A) and (B) shown in Table 1 or Table 2 were placed in a planetary mixer (manufactured by Dalton Corporation), stirred and mixed at room temperature for 1 hour, and further stirred and mixed at 120° C. for 1 hour, to obtain a thermally conductive composition. The amount of component (B) is given in terms of parts by mass relative to 100 parts by mass of component (A). The viscosity and the thermal conductivity of each of the compositions were measured. The results thus obtained are shown in Table 1 and Table 2.

TABLE 1

| | | Examples | | | | | | | | |
|---|---|---|---|---|---|---|---|---|---|---|
| | | 1 | 2 | 3 | 4 | 5 | 6 | 7 | 8 | 9 |
| (A) | AIN (1 μm) | 20 | 20 | 20 | 20 | 20 | 20 | 20 | 20 | 20 |
| | AIN (5 μm) | 20 | 20 | 20 | 20 | 20 | 20 | 20 | 20 | 20 |
| | AIN (50 μm) | 60 | 60 | 60 | 60 | 60 | 60 | 60 | 60 | 60 |
| | Total (% by mass) | 100 | 100 | 100 | 100 | 100 | 100 | 100 | 100 | 100 |
| (B) | Alkoxysilane (parts by mass) | 19.84 | 16.02 | 12.75 | 10.00 | 9.92 | 7.44 | 6.98 | 6.53 | 6.31 |

| | | | | | | | | | |
|---|---|---|---|---|---|---|---|---|---|
| Viscosity (Pa · s) | 6.6 | 13.4 | 33.4 | 87.0 | 89.0 | 214.0 | 250.0 | Paste | Shape forming limit |
| Thermal conductivity [W/(m · K)] | 2.37 | 3.00 | 3.84 | 5.18 | 5.14 | 7.27 | 7.72 | 8.02 | 8.24 |

TABLE 2

| | | Examples | | | | | | | | |
|---|---|---|---|---|---|---|---|---|---|---|
| | | 10 | 11 | 12 | 13 | 14 | 15 | 16 | 17 | 18 |
| (A) | AIN (1 μm) | 19 | 19 | 15 | 15 | 19 | 20 | 20 | 20 | 19 |
| | AIN (5 μm) | 24 | 24 | 30 | 30 | 24 | 20 | 20 | 20 | 24 |
| | AIN (80 μm) | 57 | 57 | 55 | 55 | 57 | 60 | 60 | 60 | 57 |
| | Total (% by mass) | 100 | 100 | 100 | 100 | 100 | 100 | 100 | 100 | 100 |
| (B) | Alkoxysilane (parts by mass) | 12.9 | 12.9 | 8.89 | 7.43 | 7.43 | 7.43 | 6.97 | 6.73 | 6.53 |

| | | | | | | | | | |
|---|---|---|---|---|---|---|---|---|---|
| Viscosity (Pa · s) | 59.6 | 55.0 | 155.0 | 288.0 | 312.0 | 352.0 | Paste | Paste | Shape forming limit |
| Thermal conductivity [W/(m · K)] | 4.78 | 4.78 | 6.67 | 8.15 | 8.25 | 8.49 | 8.63 | 9.05 | 9.29 |

As can be seen from a comparison between Table 1 and Table 2, the compositions of Examples 1 to 9 including aluminum nitride having an average particle size of 50 μm and the compositions of Examples 10 to 18 including aluminum nitride having an average particle size of 80 μm show that Examples 1 to 9 are smaller in viscosity, and Examples 10 to 18 are higher in thermal conductivity. It is to be noted that “shape forming limit” in Table 1 and Table 2 means that molding can be made, and any portion being unable to be molded and remaining in a powder state is not contained. It is also to be noted that “paste” means a paste (grease) state that made the measurement of the viscosity impossible.

### Examples 19 to 22

Components (A) and (B) shown in Table 3 were placed in a planetary mixer (manufactured by Dalton Corporation), stirred and mixed at room temperature for 1 hour, and further stirred and mixed at 120° C. for 1 hour, to obtain a thermally conductive composition. The amount of component (B) is given in terms of parts by mass relative to 100 parts by mass of component (A). The viscosity and the thermal conductivity of each of the compositions were measured by the above-described methods. The results thus obtained are shown in Table 3.

TABLE 3

| | | Examples | | | |
|---|---|---|---|---|---|
| | | 19 | 20 | 21 | 22 |
| (A) | Al₂O₃ (0.4 μm) | 19 | 22 | 22 | 22 |
| | AlN (5 μm) | 24 | 23 | 23 | 23 |
| | AlN (80 μm) | 57 | 55 | 55 | 55 |
| | Total (% by mass) | 100 | 100 | 100 | 100 |
| (B) | Alkoxysilane (parts by mass) | 12.8 | 12.2 | 7.13 | 5.45 |

| | | | | |
|---|---|---|---|---|
| Viscosity (Pa · s) | 46.4 | 52.4 | 176.0 | Shape |
| | | | | forming |
| | | | | limit |
| Thermal conductivity [W/(m · K)] | 4.56 | 4.86 | 8.77 | 10.88 |

As can be seen from a comparison between Table 3 and Table 2, the thermal conductivity was able to be enhanced while the increase of the viscosity was being suppressed, by including in component (A) the alumina having an average particle size of less than 1 μm in an amount of 10% by mass or more. It is to be noted that “shape forming limit” in Table 3 means the same as described above.

### Comparative Examples 1 to 16

Components (A) and (B) shown in Table 4, Table 5, or Table 6 were placed in a planetary mixer (manufactured by Dalton Corporation), stirred and mixed at room temperature for 1 hour, and further stirred and mixed at 120° C. for 1 hour, to obtain a thermally conductive composition for comparison. The amount of component (B) is given in terms of parts by mass relative to 100 parts by mass of component (A). The viscosity and the thermal conductivity of each of the compositions were measured. The results thus obtained are shown in Table 4 to Table 6. It is to be noted that “shape forming limit” in each of Table 5 and Table 6 means the same as described above.

TABLE 4

| | | Comparative Examples | | | |
|---|---|---|---|---|---|
| | | 1 | 2 | 3 | 4 |
| (A) | AlN (1 μm) | 100 | | | |
| | AlN (5 μm) | | 100 | | |
| | AlN (50 μm) | | | 100 | |
| | AlN (80 μm) | | | | 100 |
| | Total (% by mass) | 100 | 100 | 100 | 100 |
| (B) | Alkoxysilane (parts by mass) | 24.34 | 24.34 | 24.34 | 24.34 |

| | | | | |
|---|---|---|---|---|
| Viscosity (Pa · s) | 200.0 | 14.0 | 4.1 | 9.2 |
| Thermal conductivity [W/(m · K) | 1.61 | 1.66 | 1.65 | 2.48 |

TABLE 5

| | | Comparative Examples | | | | | |
|---|---|---|---|---|---|---|---|
| | | 5 | 6 | 7 | 8 | 9 | 10 |
| (A) | AlN (1 μm) | 40 | 40 | 40 | 40 | 40 | 40 |
| | AlN (5 μm) | 60 | 60 | 60 | 60 | 60 | 60 |
| | Total (% by mass) | 100 | 100 | 100 | 100 | 100 | 100 |
| (B) | Alkoxysilane (parts by mass) | 29.75 | 24.34 | 19.84 | 16.02 | 15.33 | 14.00 |

| | | | | | | |
|---|---|---|---|---|---|---|
| Viscosity (Pa · s) | 7.0 | 13.6 | 39.0 | 168.0 | 272.0 | Shape |
| | | | | | | forming |
| | | | | | | limit |
| Thermal conductivity [W/(m · K) | 1.25 | 1.52 | 1.80 | 2.28 | 2.39 | 2.47 |

TABLE 6

| | | Comparative Examples | | | | | |
|---|---|---|---|---|---|---|---|
| | | 11 | 12 | 13 | 14 | 15 | 16 |
| (A) | Al₂O₃ (0.4 μm) | 33 | 33 | 33 | 33 | 33 | 33 |
| | AlN (5 μm) | 67 | 67 | 67 | 67 | 67 | 67 |
| | Total (% by mass) | 100 | 100 | 100 | 100 | 100 | 100 |
| (B) | Alkoxysilane (parts by mass) | 18.6 | 15.1 | 12.0 | 9.82 | 9.68 | 8.58 |

| | | | | | | |
|---|---|---|---|---|---|---|
| Viscosity (Pa · s) | 6.45 | 12.3 | 40.4 | 444.0 | 704.0 | Shape |
| | | | | | | forming |
| | | | | | | limit |
| Thermal conductivity [W/(m · K) | 1.60 | 2.24 | 2.68 | 3.52 | 3.77 | 4.21 |

From a comparison between Examples in Table 1 to Table 3 and Comparative Examples 1 to 4 in Table 4, it was possible to verify that by allowing component (A) to be a mixture formulated with specific ratios of fillers having different average particle sizes, the viscosity and the thermal conductivity were able to be improved.

From a comparison between Examples in Table 1 to Table 3 and Comparative Examples 5 to 16 in Table 5 and Table 6, it was possible to verify that by including an aluminum nitride having an average particle size of 50 μm or more, the viscosity and the thermal conductivity was able to be improved.

Examples 1 and 2 in Table 1 and Comparative Examples 7 and 8 in Table 5 are the same in the amounts formulated of component (A) and component (B), respectively; however, Examples 1 and 2 were lower in viscosity and larger in thermal conductivity.

### INDUSTRIAL APPLICABILITY

The thermally conductive composition of the present invention can be used as heat dissipating materials for various devices having heat-generating portions such as electronic devices such as personal computers.

1. A thermally conductive composition comprising (A) a spherical thermally conductive filler and (B) an alkoxysilane compound or dimethylpolysiloxane,
wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more.

2. The thermally conductive composition according to claim 1, wherein the mixture of component (A) is formulated with a spherical thermally conductive filler made of a nitride and having an average particle size of 50 μm or more in an amount of 50% by mass or more, and is formulated with a spherical thermally conductive filler having an average particle size of less than 50 μm in an amount of 50% by mass or less.

3. A thermally conductive composition comprising (A) a spherical thermally conductive filler and (B) an alkoxysilane compound or dimethylpolysiloxane,
wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more, and being formulated with a spherical thermally conductive filler having an average particle size of less than 1 μm in an amount of 10% by mass or more.

4. The thermally conductive composition according to claim 3, wherein the mixture of component (A) is formulated with a spherical thermally conductive filler made of a nitride and having an average particle size of 50 μm or more in an amount of 30% by mass or more; is formulated with a spherical thermally conductive filler having an average particle size of less than 1 μm in an amount of 10% by mass or more; and is formulated with a spherical thermally conductive filler having an average particle size of 1 μm or more and less than 50 μm as a balance.

5. The thermally conductive composition according to claim 1, wherein the nitride is aluminum nitride or boron nitride.

6. A heat dissipating material consisting of the thermally conductive composition according to claim 1.
